(19) United States
(12) Patent Application Publication
(10) Pub. No.: US 2020/0009683 A1
(43) Pub. Date: Jan. 9, 2020

(54) PROCESSING METHOD, PROCESSING SYSTEM, AND PROCESSING PROGRAM

(71) Applicant: DGSHAPE Corporation, Hamamatsu-shi (JP)

(72) Inventors: Makoto YOSHIDA, Hamamatsu-shi (JP); Toshio MAEDA, Hamamatsu-shi (JP); Jun UEDA, Hamamatsu-shi (JP)

(21) Appl. No.: 16/459,647

(22) Filed: Jul. 2, 2019

(30) Foreign Application Priority Data
Jul. 6, 2018 (JP) 2018-129258

(51) Int. Cl. B23K 26/00; B23K 26/08; B23K 26/10; B23K 26/38; B23K 26/402; B23K 26/53

(52) U.S. Cl. CPC B23K 26/0093; B23K 26/0884; B23K 26/10; B23K 2103/52; B23K 26/402; B23K 26/53; B23K 26/38

(57) ABSTRACT

A processing method for forming an object by processing a material using a cutting tool and a laser beam, including forming, by projecting the laser beam to an unnecessary portion of the material, one or more cleavage regions in the unnecessary portion, and cutting, using the cutting tool, the unnecessary portion including the one or more cleavage regions that have been formed.

### CROSS REFERENCE TO RELATED APPLICATIONS

This application claims the benefit of priority to Japanese Patent Application No. 2018-129258 filed on Jul. 6, 2018. The entire contents of this application are hereby incorporated herein by reference.

### BACKGROUND OF THE INVENTION

### 1. Field of the Invention

The present invention relates to processing methods, processing systems, and processing programs.

### 2. Description of the Related Art

Cut processing is a method of producing objects by bringing a cutting tool into contact with the surface of a material to cut and remove unnecessary portions (see, for example, JP-A-10-244439).

Cut processing is performed by moving a cutting tool T on a predetermined processing path, from the top along the z-axis, relative to a fixed material M as shown in FIG. 8 as an example to cut a process site.

In cases where hard materials are subjected to cut processing, the processing path must be divided or the speed of moving each cutting tool must be reduced to avoid the breakage of cutting tools. Thus, hard materials require longer cut-processing time.

Typical cutting tools have a large diameter of 0.1 mm; thus, holes or grooves smaller than the tool diameter (sites where cut processing is difficult to be performed) cannot be processed.

Some techniques have also been known which achieve processing of materials using a thermal processing with high-power lasers such as CO2 lasers. Thermal processing can be used to cut and separate an unnecessary portion of a material. In addition, sites where cut processing is difficult to be performed can also be processed because laser beams have a spot diameter smaller than diameters of cutting tools (such as 0.01 mm).

However, the distance between processing paths must be small because laser beams have a small spot diameter. Therefore, this technique requires longer processing times.

Furthermore, configurations with which processing can be performed by combining cutting and laser cutting (“combination processing”) have been considered.

For example, TRANSACTIONS OF THE JAPAN SOCIETY OF MECHANICAL ENGINEERS Series C 79(808), 4582-4592, 2013 and 23rd Conference of JSPE Student Member Graduation Research of The Japan Society for Precision Engineering, pp. 115-116, disclose configurations in which materials are locally heated with a laser and the portion softened by heating is cut and removed using a cutting tool.

However, in cases where laser beams are projected for the purpose of heating materials as described in TRANSACTIONS OF THE JAPAN SOCIETY OF MECHANICAL ENGINEERS Series C 79(808), 4582-4592, 2013 and 23rd Conference of JSPE Student Member Graduation Research of The Japan Society for Precision Engineering, pp. 115-116, these laser beams supply heat to a portion to be subjected cut and removal and its vicinity, softening the material and causing it to deform or deteriorate. In this case, the process would possibly deteriorate the quality of the object. Such effects of deformation and deterioration of the material become more apparent when small objects such as dentistry protheses are processed.

### SUMMARY OF THE INVENTION

Preferred embodiments of the present invention provide processing methods that reduce processing time while reducing effects of deformation and deterioration of materials due to heat, and also provide processing systems for performing such processing methods, and processing programs executed by the processing systems.

A preferred embodiment of the present invention is a processing method for forming an object by processing a material using a cutting tool and a laser beam, including a projection step of forming, by projecting the laser beam to an unnecessary portion of the material, one or more cleavage regions in the unnecessary portion; and a cutting step of cutting, using the cutting tool, the unnecessary portion including the one or more cleavage regions that have been formed.

According to a preferred embodiment of the present invention, it is possible to reduce processing time while reducing effects of deformation and deterioration of materials due to heat.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram showing a configuration of a processing system according to a preferred embodiment of the present invention.

FIG. 2A is a diagram schematically showing a process site according to a preferred embodiment of the present invention.

FIG. 2B is a diagram schematically showing process sites according to a preferred embodiment of the present invention.

FIG. 2C is a diagram schematically showing cutting paths according to a preferred embodiment of the present invention.

FIG. 3A is a diagram schematically showing a process site according to a preferred embodiment of the present invention.

FIG. 3B is a diagram schematically showing process sites according to a preferred embodiment of the present invention.

FIG. 3C is a diagram schematically showing a cutting path according to a preferred embodiment of the present invention.

FIG. 4 is a flow chart showing a sequence of operations of a processing system according to a preferred embodiment of the present invention.

FIG. 5A is a diagram for explaining a processing method according to a preferred embodiment of the present invention.

FIG. 5B is a diagram for explaining a processing method according to a preferred embodiment of the present invention.

FIG. 5C is a diagram for explaining a processing method according to a preferred embodiment of the present invention.

FIG. 5D is a diagram for explaining a processing method according to a preferred embodiment of the present invention.

FIG. 6 is a flow chart showing a sequence of operations of a processing system according to a preferred embodiment of the present invention.

FIG. 7A is a diagram for explaining a processing method according to a preferred embodiment of the present invention.

FIG. 7B is a diagram for explaining a processing method according to a preferred embodiment of the present invention.

FIG. 8 is a diagram for explaining a conventional processing method.

### DETAILED DESCRIPTION OF THE PREFERRED EMBODIMENTS

Processing methods according to preferred embodiments of the present invention process materials using laser processing and cutting in combination (combination processing) to fabricate objects.

For materials of preferred embodiments of the present invention, both light-transmitting materials and opaque materials can be used. Light-transmitting materials are highly transparent to wavelengths of laser beams, allowing them to penetrate deeper into the materials. Examples of light-transmitting materials that can be used include glass ceramics and zirconia-based materials. Glass ceramics may be those that are doped with certain elements or particles. Zirconia-based materials may be composite materials such as zirconia-containing glass ceramics or zirconia alone with a certain transmittance. Light-transmitting materials do not require 100% or equivalent light transmittance or have high transmittance as glass or PMMA within a visible light range. Any transmittance value will suffice as long as the laser beam reaches a certain region (process site) for processing. Opaque materials are less transparent to wavelengths of laser beams, making it difficult to pass through them. Examples of opaque materials that can be used include materials whose transparency decreases at a certain wavelength or a wavelength range such as when resin materials are used with a wavelength of a UV range or glass processing using a CO2 laser.

Laser processing is a method of processing materials by projecting a laser beam. In the laser processing of this preferred embodiment, both of laser beams for thermal processing and laser pulses for non-thermal processing (ablation) can be used.

Thermal processing is a method that uses laser beam projection on the surface of the material for melting the process site(s). For laser beams for thermal processing, for example, CO2 lasers can be used.

Non-thermal processing is a method of projecting a laser beam onto the material surface or into the material to form, in a process site, a cavity or a portion whose characteristics have been changed. For laser beams for non-thermal processing, the light emitted from a short-puled laser can be used. In particular, it is preferable to use the light emitted from an ultrashort-pulsed laser to project a laser beam directly to a process site inside a material. Ultrashort-pulsed lasers emit laser pulses with durations between picoseconds and femtoseconds. Ablation can be performed by exposing a process site inside the material to laser pulses emitted from an ultrashort-pulsed laser for a short duration. During ablation, the portion of material that is molten using the laser pulses instantaneously evaporates and scatters, thus being eliminated. Therefore, damage to each process site due to heat is lower than that using thermal processing. Therefore, ablation is particularly effective for processing small-sized objects, such as prostheses used for dental care.

Cut processing is a method of cutting a material using one or more tools. Tools are cutting tools used for cutting materials, such as drills and end mills. Cutting tools have a blade to cut materials.

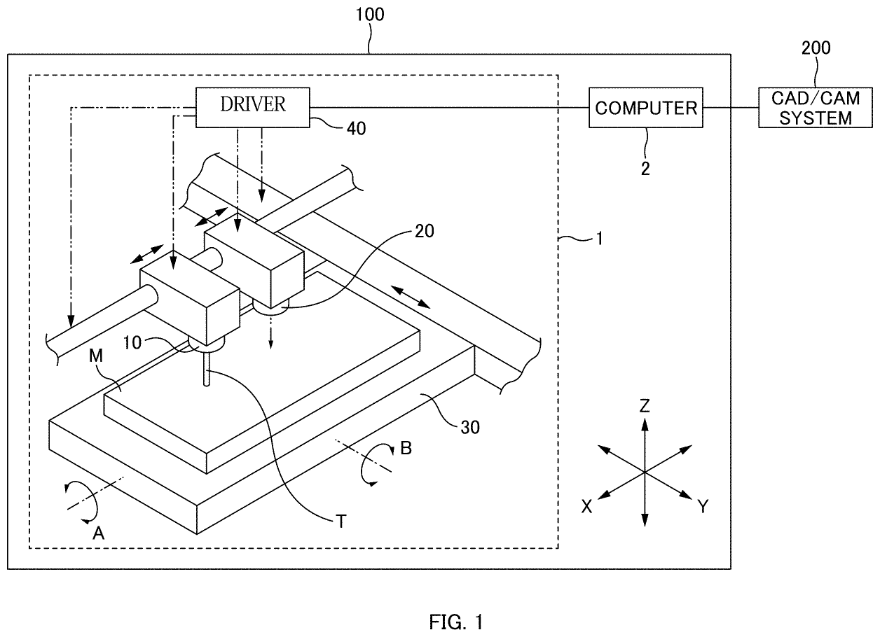

The combination processing according to this preferred embodiment is performed based on processing data (described later) generated beforehand. In addition, the processing method according to this preferred embodiment is performed by a processing system 100 as shown in FIG. 1. The processing system 100 performs processing of the material M based on a processing data generated by a CAD/CAM system 200. Hereinafter, “processing data,” “processing system,” and “processing by the processing system (processing method)” are described in detail.

Processing data are used by the processing system 100 to obtain an object by processing the material M. Each processing data is generated in the CAD/CAM system 200 based on three-dimensional data of an object and three-dimensional data of the material M. For example, when processing a prosthesis for dental care, a processing data is generated using three-dimensional data obtained by scanning the oral cavity with a CCD camera or an X-ray CT. The three-dimensional data of each object is STL data or solid data used in three-dimensional CAD or data such as 3 MF or AMF used in 3D printers.

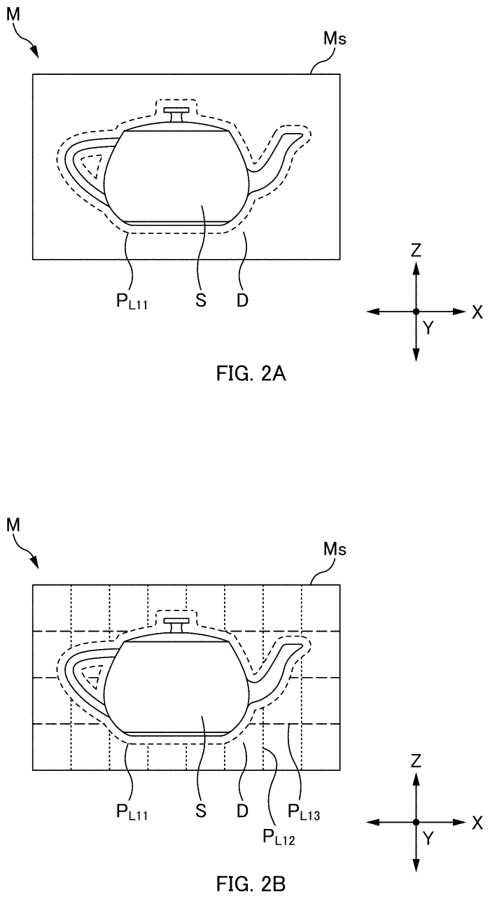

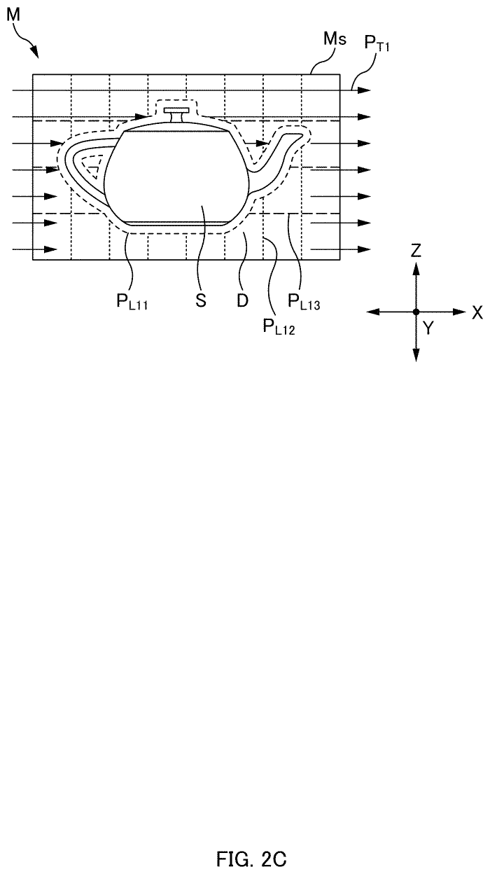

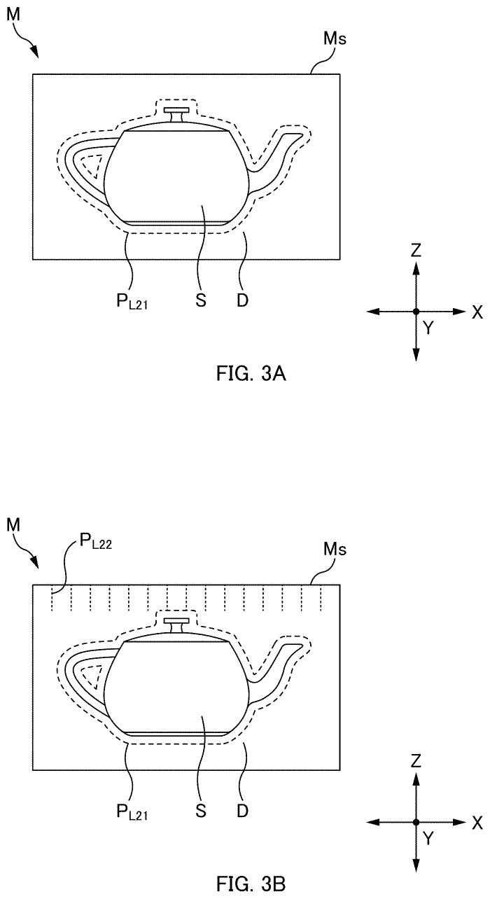

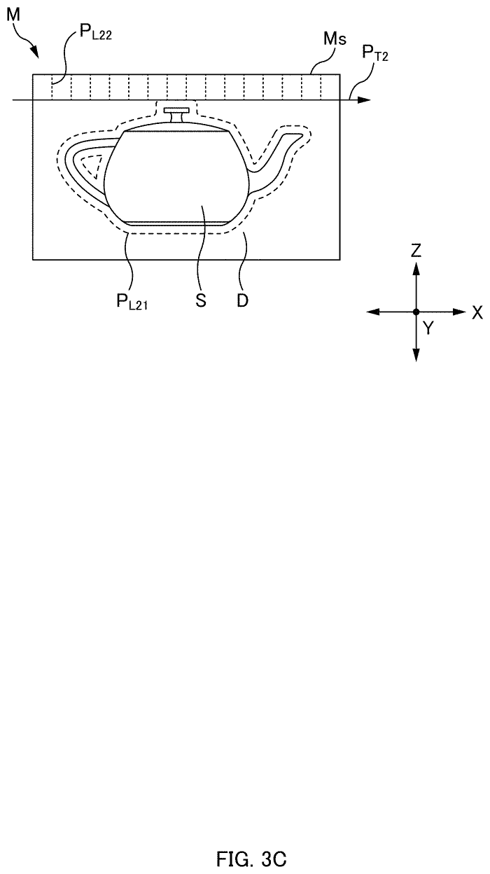

Referring to FIG. 2A to FIG. 3C, the processing data is described in detail. The processing data according to this preferred embodiment includes projection data and cut data. FIGS. 2A, 2B, 3A, and 3B show examples of process sites based on the projection data. FIGS. 2C and 3C are examples of cutting paths based on cut data. The x-, y-, and z-axes shown in FIGS. 2A to 3C are three axes perpendicular to each other (the same applies to the description below).

Projection data are used for laser processing. Projection data include at least process site data, order data, and projection path data. The number of these data generated depends on the number of the process sites.

Process site data are for designating process sites. Process sites are regions on the surface of the material M or in the material M which are set to form cleavage regions. A cavity or a portion whose characteristics have been changed is formed, depending on the spot diameter of the laser beam, in the process site that has been exposed to the laser beam. Each cleavage region is formed by projecting a laser beam along a process site and forming cavities or portions whose characteristics have been changed in the entire process site.

Each process site can have one of various shapes. Two of them, a first example and a second example, are illustrated below.

In the first example, the process site includes process site PL11, process sites PL12, and process sites PL13. The process site PL11 is provided at a site corresponding to the surface of an object S (see FIG. 2A). The process site PL11 is provided at a certain distance outward from the surface of the object S. The process sites PL12 are provided in a first direction from a surface Ms of the material M (see FIG. 2B). The first direction is parallel to the z-direction. The process sites PL12 are spaced away from each other at certain distances. The process sites PL13 are provided in a second direction perpendicular to the first direction (see FIG. 2B). The second direction is parallel to the y-direction. The process sites PL13 are spaced away from each other at certain distances. It should be noted that the process sites PL12 and PL13 are not provided in the object S (inside the process site PL11).

In the second example, the process site includes a process site PL21 and process sites PL22. The process site PL21 is provided at a site corresponding to the surface of an object S (see FIG. 3A). The process site PL21 is provided at a certain distance outward from the surface of the object S. The process sites PL22 are provided in a first direction from a surface Ms of the material M (see FIG. 3B). The first direction is parallel to the z-direction. The process sites PL22 are spaced away from each other at certain distances.

It should be noted that, in FIG. 3B, only a portion of each process site PL22 is shown. The actual process sites PL22 are set from the surface Ms to the opposite surface (the back side of the surface Ms) of the material M parallel to the z-axis. While details are described later, in the processing using the processing data in the second example, the projection of a laser beam (projection step) and cutting using a cutting tool T (cutting step) are alternately performed. Therefore, in a single projection step, a laser beam is projected only to one or more process sites PL22 that are going to be subjected to cutting in the following single cutting step out of the process sites PL22 that are set parallel to the z-axis (i.e., only some of the process sites PL22). Furthermore, the process sites PL22 are not provided in the object S (inside the process site PL21).

One process site data consists of a plurality of point data that are arranged in one- or two-dimensions. In the first example, the point data representing the process site PL11 form a two-dimensional curved surface; the point data representing the process sites PL12 form one-dimensional line segments parallel to the z-axis; and the point data representing the process sites PL13 form one-dimensional line segments parallel to the x-axis. In addition, in the second example, the point data representing the process site PL21 form a two-dimensional curved surface and the point data representing the process sites PL22 form one-dimensional line segments parallel to the z-axis. The point data are set at certain intervals in consideration of, for example, the size of the material M and the shape of the object S. Each point data has three-dimensional (XYZ) coordinate values and vector information.

Each ordered triple is used in determining a focal position of a laser beam (i.e., each ordered triple corresponds to the position at which a laser beam is projected on the surface of the material M or in the material M). The focal position of the laser beam varies depending on the refractive index of the material M. Accordingly, one or more coordinates may be corrected in consideration of the refractive index of the material M. The vector information is used in setting the direction of projection of the laser beam. In the case that a laser beam is directed into the material M, an effect of reflection from the surface of the material M occurs. Accordingly, it is more preferable to set the vector information such that each laser beam is directed vertically to the surface of the material M. It should be noted that the process site data is not limited to a plurality of point data. Instead, it may be one- or two-dimensional region data that specify a range in which the laser beam is projected to the material M.

The order data represents, when two or more process sites are set, to which one of the process sites a laser beam is projected first (the order of projecting the laser beam). Here, in the event that some process sites are layered in a direction of projection of the laser beam, the order data is set such that the laser beam is projected in descending order of distance from the surface of the material M through which the laser beam passes (in a series that begins with the farthest and ends with the closest to the surface of the material M). The distance between the surface of the material M and each process site is determined along the aforementioned direction of projection of the laser beam. In the event that one process site data consists of a plurality of point data, the order data may include data representing at which ordered triple represented by which point data the laser is projected first.

For example, in the first example, for the process site data, three-dimensional coordinate values representing the positions of the process sites PL11 to PL13 and the direction of projection of the laser beam are set. Here, in the first example, it is assumed that the direction of projection of the laser beam is set from the top downward in a direction parallel to the z-axis (i.e., such that the laser beam is directed through the surface Ms).

In this case, for example, the process site PL11 has a two-dimensional curved shape and has portions that are layered in a direction of projection of the laser beam. Accordingly, the order data may be set such that the coordinate values represented by the point data farthest from the surface Ms of the material M come first and the coordinate values represented by the point data closest to the surface Ms come last. On the other hand, in the case that there exists a process site that is not layered in the direction of projection of the laser beam, the order data is also assigned to that process site; provided that the order of projection of the laser beam to (the order of processing of) the process site is not limited. For example, the projection of the laser beam to the process site that is not layered may be performed before the projection to the process sites that are layered or performed after the projection of the laser to all of the layered process sites have been completed. Alternatively, the projection of the laser beam to the process site that is not layered may be performed during the processing of the layered process sites. The same applies to the process site PL21 in the second example.

Each of the plurality of process sites PL12 is a process site with a length in the z-direction. Accordingly, in each process site PL12, the order data is set such that the coordinate values represented by the point data farthest from the surface Ms of the material M through which the laser beam passes along the z-direction come first and the coordinate values represented by the point data closest to the surface Ms come last. That is, in each of the process sites PL12, the order of processing is set from the bottom up along the z-axis. The same applies to the process sites PL22 in the second example.

Furthermore, the plurality of process sites PL13 are layered in a direction of projection of the laser beam. Accordingly, the order data is set such that the process site farthest from the surface Ms of the material M through which a laser beam passes along the z-axis comes first (no. 1) and the process site closest to the surface Ms of the material M comes last, among the process sites PL13. That is, in each of the process sites PL13, the order of processing is set from the bottom up along the z-axis.

The projection path data is for setting a path of projecting a laser beam in a process site. For example, in the first example, a path indicating that a laser beam is projected along the surface of the object S is set to the projection path data for the process site PL11. A path indicating that a laser beam is projected along the z-axis is set to the projection path data for the process sites PL12. A path indicating that a laser beam is projected along the x-axis is set to the projection path data for the process sites PL13. Note that the projection path data may be included in the order data. In such cases, for example, the projection path data for the process site is set such that the laser beam is vertically projected from the bottom up along the z-axis.

Furthermore, the projection data may include data representing a surface contour of the object and data used in, for example, a finishing step described later. Moreover, the processing data for the laser projection may include information related to the power of the laser beam (e.g., a spot diameter, projection time, intensity of the laser beam projected at each point).

Cut data are used for a cut processing. The cut data include at least cutting path data. Each cutting path data is a data in which relative position between a grasper 10 and a holder 30 are arranged chronologically.

FIG. 2C is a diagram illustrating cutting paths PT1 (arrows) along which the cutting tool T moves according to the cutting path data in the first example. In FIG. 2C, it is impossible to bring the cutting tool T into contact with, for example, a portion located under the object S in the material M in the illustrated orientation. The material M needs to be rotated or turned to cut and process that portion.

In the first example, the cutting paths PT1 are set at certain distances in the z-direction. Each of the cutting paths PT1 is set parallel to the x-axis. The arrows in FIG. 2C indicate the direction in which the cutting tool T moves (from left to right parallel to the x-axis). While details are described later, the cutting tool T moves from the uppermost cutting path PT1 to the lowermost cutting path PT1 one by one along the z-direction.

FIG. 3C is a diagram showing a cutting path PT2 (arrow) along which the cutting tool T1 moves during the cut processing in the second example. The cutting path PT2 is set parallel to the x-axis and set such that it locates on the same depth as the lower end of the process site PL22. The arrow in FIG. 3C indicates the direction in which the cutting tool T moves (from left to right parallel to the x-axis).

It should be noted that, in FIG. 3C, only one cutting path PT2 is illustrated; however, in practice, two or more cutting paths PT2 are set. As mentioned in the description of the projection data, during the processing using the processing data in the second example, the projection of a laser beam (projection step) and cutting using a cutting tool T (cutting step) are alternately performed. Therefore, a cutting path PT2 is set for each of the repeated cutting steps.

It should be noted that the CAD/CAM system 200 may generate the processing data in consideration of property values of the material M as well as the shape and properties of the cutting tool T. The CAD/CAM system 200 is configured or programmed to input this information and may include a keyboard or a selection screen displayed on a display to input this information.

A refractive index is an example of the property value of the material M. As described above, when generating projection data, the projection position (focal position) of the laser beam is corrected in consideration of the refractive index of the material M.

The shape and property of the cutting tool T are, for example, the diameter of the cutting tool T, the shape of its blade, and the length of the blade. For example, some surface contours of an object S can have irregularities that are finer or smaller than the diameter of cutting tools T; such cutting tools T cannot be used for cutting all of the unnecessary portions D. By considering the diameter of the cutting tool T, a cutting path in which only the unnecessary portion D that can be cut out can be cut using the cutting tool T is set. Furthermore, cutting resistance against the material M depends not only on the hardness of the material M but also the shape of the blade of the cutting tool T. By considering the shape of the blade of the cutting tool T, the distance between cutting paths and the speed of moving the cutting tool T are set. Cutting depths to cut the material M at once increases with increasing blade length of the cutting tool T. By considering the blade length of the cutting tool T, the distance between the cutting paths along the z-direction is adjusted.

FIG. 1 is a diagram schematically showing the processing system 100. The processing system 100 includes a processor 1 and a computer 2. The processing system 100, however, may include a processor 1 alone when the functions of the computer 2 are integrated into the processor 1.

The processor 1 according to this preferred embodiment has five driving axes (the x-, y-, and z-axes as well as the A-rotation axis (the rotation axis around the x-axis) and B-rotation axis (the rotation axis around the y-axis)). The processor 1 processes the material M using the cutting tool T after projecting a laser beam to the process site based on the processing data. The processor 1 includes the grasper 10, a projector 20, the holder 30, and a driver 40.

The grasper 10 grasps the cutting tool T. The grasper 10 includes a spindle, a motor, and other components. The spindle holds the base of the cutting tool T and makes it rotatable about the axial center of the cutting tool T. The motor rotates the spindle. As the spindle rotates, the cutting tool T turns.

The projector 20 projects laser beams to the material M. The projector 20 includes a laser oscillator and an optical system including a group of lenses and a galvanometer mirror to direct the laser beam produced by the oscillator to the material M.

The holder 30 holds a material M. Any method can be used for holding the material M. For example, it is possible to use, as in the case of conventional cut processing, a method of clamping and holding a disk-shaped material M using a clamp or a method of bonding a metal pin to a block-shaped material M and inserting the pin into the holder 30 to hold the material. The driver 40 includes a drive motor and other components. The driver 40 moves the grasper 10, the projector 20, and the holder 30 relative to each other.

It should be noted that an adjuster that adjusts projection patterns of the laser may be provided. The adjuster may be a galvanometer mirror, a Fresnel lens, a diffractive optical element (DOE), or a spatial light phase modulator (LCOS-SLM). The adjuster is disposed, for example, between the oscillator and the group of lenses in the projector 20.

Spatial light phase modulators can adjust the laser beam produced by an oscillator into a desired shape by adjusting the liquid crystal orientation. For example, a spatial light phase modulator can project a linear laser beam (a laser beam with a one-dimensional shape) by shaping the focal point of a beam from a point laser into a line. By using such a spatial light phase modulator, a projection processing using a laser beam to a one-dimensional process site in the entire process site can be performed via a single projection. In other words, by using a spatial light phase modulator, all the process sites can be processed in a one-dimensional region at once, reducing processing time.

The computer 2 controls the operations of the grasper 10, the projector 20, the holder 30, and the driver 40. Specifically, the computer 2 adjusts the relative position between the projector 20 and the holder 30 (the material M) by controlling the driver 40 such that the laser beam can be projected to a process site corresponding to a processing data on the surface Ms of the material M or inside the material M. Furthermore, the computer 2 controls the projector 20 to adjust the focal position of each laser beam as well as the spot diameter and intensity of the projected laser beam and to project a laser beam to the material M for a certain amount of time. The spot diameter, intensity, and projection time affect the power (energy) of the projected laser beam. These parameters may be included beforehand in the processing data as described above, or may be set in the processor 1. For determining these values, the type and/or the property of the material M to be processed can be considered. Furthermore, the computer 2 can control the projector 20 to switch on and off of the laser beam and change the type of the laser beam. For example, the computer 2 can control the projector 20 and change the type of the laser beam between the one for thermal processing and the one for non-thermal processing depending on the type of the material M. Furthermore, the computer 2 controls the driver 40 and adjusts the relative position between the grasper 10 and the holder 30 (the material M) such that the unnecessary portion D of the material M is cut out based on the cut data. Specifically, the computer 2 makes the spindle grasp the cutting tool T and rotate the cutting tool T. The computer 2 controls the driver 40 to move the cutting tool T to a predetermined position. Furthermore, the computer 2 controls the driver 40 to hold the material M held by the holder 30 at a predetermined position and angle. Then, the computer 2 controls the driver 40 according to the cutting path data and performs cut processing by moving the blade of the cutting tool T while keeping it in contact with the material M. The computer 2 is an example of the “controller.”

Furthermore, the processing system 100 according to this preferred embodiment can perform finishing after the cut processing by adjusting the power of the laser beam produced by the projector 20. In other words, since all of the operations of processing the material M to create the object S can be performed in the processor 1, no increase in terms of processing time and reduction of procession precision is necessary or caused, which would otherwise occur owing to the attachment and detachment of the material M.

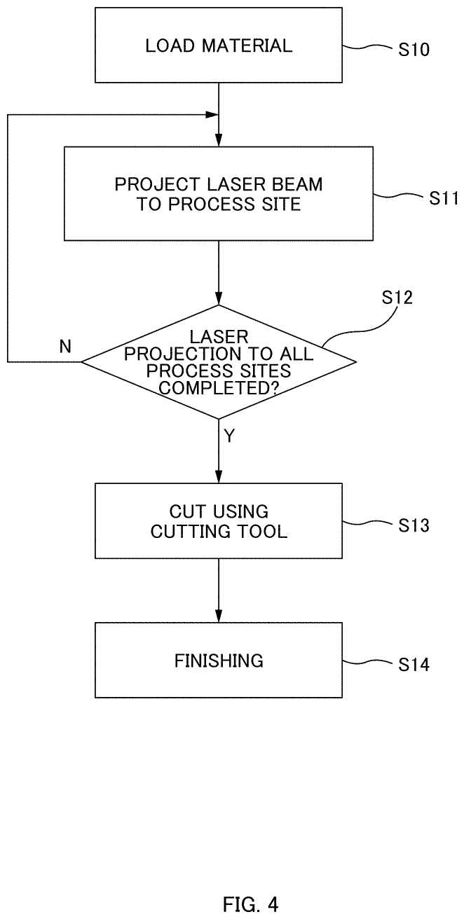

Next, referring to FIGS. 4 to 7B, a specific example of the processing method according to this preferred embodiment is described. The processing method is performed by the processing system 100. In addition, the processing method has been installed beforehand on the processing system 100 as a dedicated processing program. In this example, an object S is obtained by processing a material M.

The processing method according to this preferred embodiment includes a projection step, a cutting step, and a finishing step. The projection step is for forming, by projecting a laser beam to an unnecessary portion D of the material M, one or more cleavage regions in the unnecessary portion D. The cutting step is for cutting, using a cutting tool T, the unnecessary portion D including the one or more cleavage regions that have been formed. The finishing step is for removing, after the cutting step, a remaining unnecessary portion by projecting the laser beam to the remaining unnecessary portion.

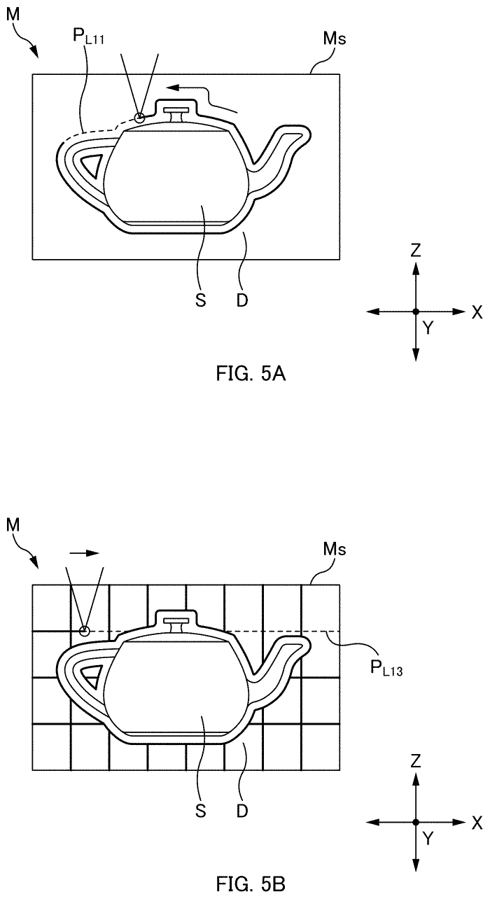

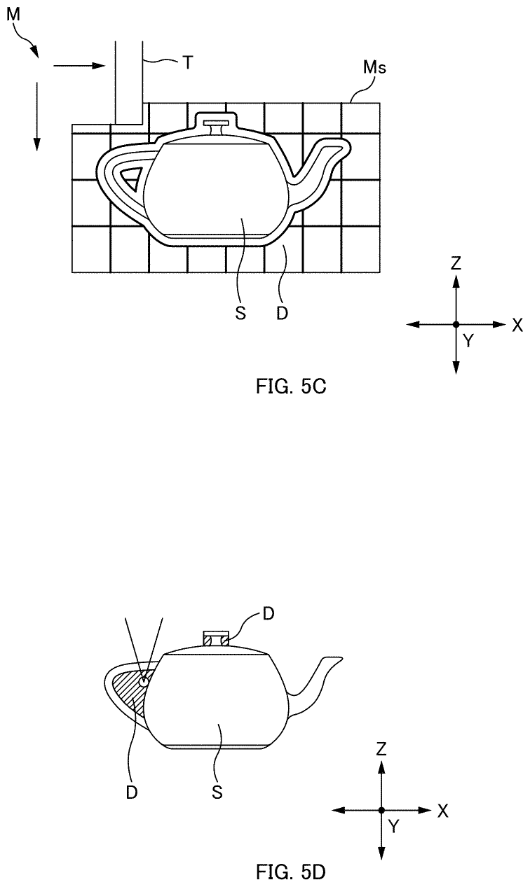

Now, processing with the processing data in the first example shown in FIGS. 2A to 2C being used is described. FIG. 4 is a flow chart showing a sequence of operations of the processing system 100 in the first example. FIGS. 5A to 5D are diagrams schematically showing the object S or the material M processed using the processing data in the first example. The processing data of the material M is assumed to have been generated beforehand by the CAD/CAM system 200.

The material M is selected and loaded into the holder 30 of the processor 1 (load the material; step 10).

Then, the computer 2 causes the processor 1 to perform the projection step based on the processing data (projection data) of the material M. The computer 2 controls the projector 20 and the driver 40 to make them project a laser beam to the position (process site) represented by the process site data included in the processing data. For this, the computer 2 projects a laser beam to a process site based on the order data (project a laser beam to a process site; step 11).

The computer 2 makes an adjustment such that the coordinate values of the point data included in the process site data match the focal position of the laser beam. Specifically, the computer 2 adjusts the relative position between the projector 20 and the holder 30 and adjusts the orientation and/or angle of the galvanometer mirror and/or the group of lenses included in the projector 20. The adjustment of the focal position can be performed considering the refractive index of the material M. After the coordinate values of the point data match the focal position of the laser beam, the computer 2 controls the projector 20 and makes it project a laser beam from the top along the z-axis for a certain amount of time, based on the vector information included in the point data.

Specifically, first, the computer 2 controls the projector 20 and the driver 40 based on the projection data to project a laser beam to the process site PL11 (FIG. 5A). Thereafter, the computer 2 controls the projector 20 and the driver 40 to project a laser beam to the process sites PL12 and the process sites PL13 (FIG. 5B). In FIGS. 5A and 5B, each process site that has not yet been processed is designated by a dotted line and each process site that has been processed is designated by a thick solid line. The order of projecting the laser beam to the process sites PL12 and the process sites PL13 is not limited, but the laser projection to the process sites PL12 precedes in this example.

It should be noted that the laser projection to the process site PL11 at the beginning causes the process site PL11 to be changed in terms of its character. Therefore, no subsequent laser projections to the process sites PL12 and PL13 result in the entry of a laser beam into the material across the position where character has been changed. In other words, the object S including its surface will never be changed in its character when the laser beam is projected to the process sites PL12 and PL13.

Furthermore, during the projection of the laser beam to the process sites PL12, the laser beam is projected to each of the process sites PL12. If the laser beam is projected from the top down along the z-axis, no laser beam can reach the portions of the process sites PL12 located under the object S because of the process site PL11 whose characteristics have been changed. Accordingly, to process the process site(s) PL12 located under the object S, a laser beam is projected from the bottom up along the z-axis.

Moreover, during the projection of the laser beam to the process sites PL13, the laser beam is projected to the process sites PL13 in descending order of distance from the surface Ms. In this case, as in the case of the process site(s) PL12, to process the process site(s) PL13 located under the object S, a laser beam is projected from the bottom up along the z-axis. By projecting the laser beam in the manner just mentioned, cleavage regions can be formed without being affected by the character change by the projection of the laser beam even when the process sites are layered in the direction of projection of the laser beam.

It should be noted that the aforementioned examples are examples in which the laser beam is projected to the material M from the top down (the laser beam is projected downward) along the z-axis or from the bottom up (the laser beam is projected upward) along the z-axis, but the present invention is not limited thereto. The laser beam may be projected to the material M from one side (the laser beam is projected laterally) along the x- or y-axis perpendicular to the z-axis. Alternatively, when the material M has a sloped surface Ms, the laser beam may be projected slanting direction. In any case, cleavage regions can be formed without being affected by the character change of the material M.

When the laser projection to all process sites has been completed in the manner mentioned above (Y at step 12), the cleavage sites have been formed in the process sites. In this case, the computer 2 controls the driver 40 based on the cut data and cuts the material M by bringing the cutting tool T into contact with the material M (FIG. 5C; cut using the cutting tool T; step 13). Then, the unnecessary portion D near the cleavage sites formed at step 11 is cut out using the cutting tool T.

After the completion of the cutting step, if the unnecessary portion D of the material M includes a portion where no cutting tool T can reach because of the shape of the object S or a portion that cannot be cut out because of the larger diameter of the cutting tool T, the unnecessary portion D is left after the cutting step.

Then, after the step 13, the computer 2 controls the projector 20 and the driver 40 to process the remaining portion (finishing; step 14). In the finishing step, the object S is obtained by projecting a laser beam to the unnecessary portion D that has been left during the cutting step to remove the unnecessary portion, based on surface contour data of the object S included in the projection data (FIG. 5D).

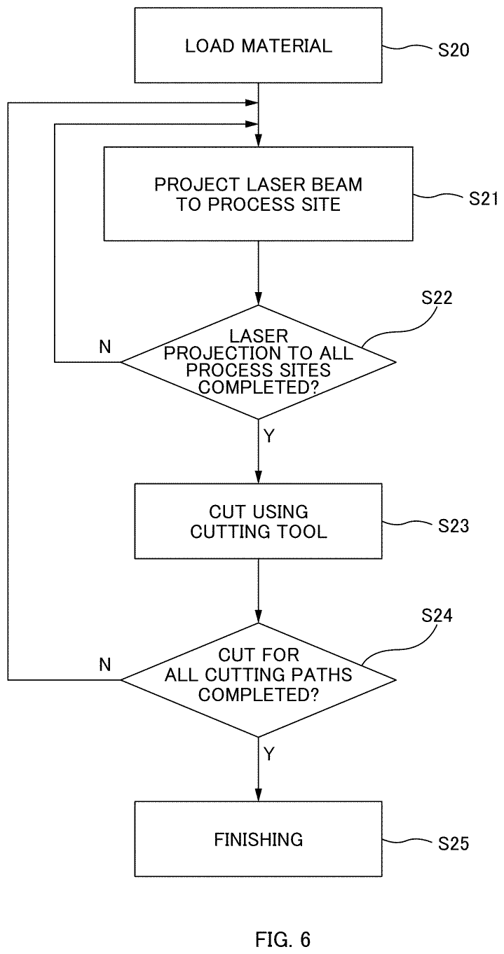

Next, processing using the process data in the second example shown in FIGS. 3A to 3C is described. FIG. 6 is a flow chart showing a sequence of operations of the processing system 100 in the second example. The second example is different from the first example in that the projection step and the cutting step are performed alternately.

First, the material M is selected and loaded into the holder 30 of the processor 1 (load a material; step 20).

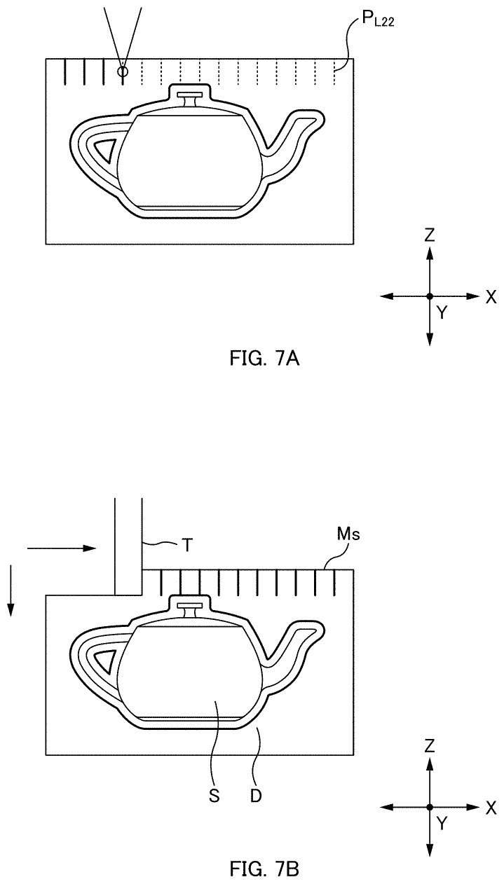

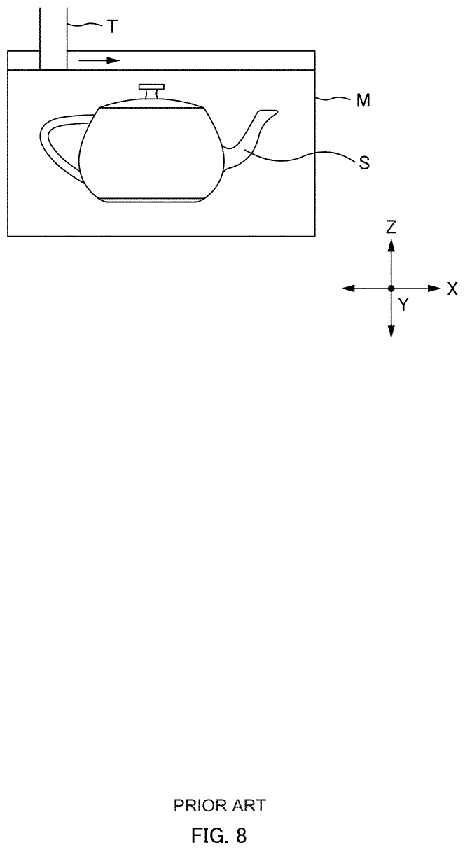

Next, the first projection step is performed. In this projection step, a laser beam is projected to the process site PL21 as in the case of the first example (FIG. 5A). Then, the laser beam is projected to the process sites PL22 (FIG. 7A; project a laser beam to a process site; step 21). In FIG. 7A, each process site that has not yet been processed is designated by a dotted line and each process site that has been processed (cleavage region) is designated by a thick solid line. The first projection step is completed when the cleavage regions are formed in the process sites PL21 and PL22 by projecting the laser beam.

After the completion of the first projection step (Y at step 22), the operation proceeds to the first cutting step (cut using the cutting tool T; step 23). During this cutting step, the computer 2 moves the cutting tool T along the cutting path PT2 represented by the cut data, and cuts the unnecessary portion D to the depth where the cleavage region that has been formed in the process site PL 21 lies (FIG. 7B). That is, only the portion of the unnecessary portion D in which the cleavage region has been formed is removed by the first cutting step. Cutting along the cutting paths for the subsequent cutting steps have not yet been completed (N at step 24).

In this case, the operation proceeds to the second projection step (step 21). In the second projection step, a cleavage region is formed, in a manner similar to the first projection step, near the surface Ms of the material M that has appeared by the first cutting step. In this case, the processing data is set such that the cleavage region is not formed inside the object S.

After the completion of the second projection step (Y at step 22), the operation proceeds to the second cutting step (step 23). In the second cutting step, the computer 2 moves the cutting tool T along the cutting path PT2 represented by the cut data, and cuts the unnecessary portion D to the depth where the cleavage region formed in the second projection step lies. In this way, in the second example, by alternating the formation of the cleavage region and the cut processing, the processing is performed from the surface Ms of the material M toward the bottom of the z-axis.

After the completion of the cutting along the all cutting paths included in the processing data (cut data) (Y at step 24), the computer 2 controls the projector 20 and the driver 40 to process the remaining portion(s) (finishing; step 14). The finishing can be performed in a manner similar to that in the first example. Through these steps, the object S is obtained.

The material M is assumed to be a light-transmitting material in the first and second examples described above; however, when the material M is an opaque material, the laser beam cannot penetrate it. Therefore, it is impossible to project the laser beam to the process sites in the aforementioned examples.

To apply the processing method according to this preferred embodiment to a material M which is an opaque material, each process site is set on a surface Ms of the material M. In this case, a laser beam for thermal processing is used. By projecting the laser beam to the process site(s) on the surface Ms of the material M, a cleavage region whose characteristics have been changed is formed near the surface Ms (formation of a cleavage region). Then, an unnecessary portion including the cleavage region that has been formed near the surface Ms is cut using a cutting tool T (cut processing).

Then, as in the aforementioned second example, the processing is performed from the surface Ms of the material M toward the bottom of the z-axis by alternating the formation of the cleavage region and the cut processing.

It should be noted that, as a result of the repeated cut processing, the surface of the object S gradually appears on the surface Ms of the material M, but the process sites to which the laser processing and cut processing are performed are set only in the surface Ms other than the surface of the object S. Accordingly, the surface of the object S is not exposed to the laser beam and does not deform or deteriorate due to heat.

As described above, the processing method according to this preferred embodiment is a processing method for forming an object S by processing a material M using a cutting tool T and a laser beam, including a projection step of forming, by projecting the laser beam to an unnecessary portion D of the material M, one or more cleavage regions in the unnecessary portion D; and a cutting step of cutting, using the cutting tool T, the unnecessary portion D including the one or more cleavage regions that have been formed.

As described above, since the cut processing is performed after the cleavage regions are formed in the unnecessary portion D using the laser beam, cutting resistance against the unnecessary portion D during the cut processing becomes smaller. Accordingly, compared with processing only with the cut processing, the number of processing paths is able to be reduced or the speed of moving the cutting tool T is able to be increased, increasing the cutting efficiency. In addition, compared with laser ablation alone, processing time is able to be reduced because unnecessary portions are removed using the cut processing. Furthermore, when cleavage portions are formed, the laser beam is selectively projected only to the unnecessary portion D, which reduces effects of deformation and deterioration of the material M due to heat on the subject S. In other words, in the processing method according to this preferred embodiment, it is possible to reduce the processing time while reducing the effects of deformation and deterioration of the material due to heat.

Furthermore, in the processing method according to this preferred embodiment, two or more cleavage regions are formed in the first direction from the surface Ms of the material M by projecting the laser beam. By forming two or more cleavage regions in a certain direction, the cutting resistance against the unnecessary portion D is able to be reduced, increasing the cutting efficiency.

Furthermore, in the processing method according to this preferred embodiment, the cleavage regions are formed, by projecting the laser beam, in a second direction that is perpendicular to the first direction. By forming the cleavage regions in the first and second directions, the unnecessary portion D is divided into blocks. By dividing the unnecessary portion D into small blocks, cutting resistance against the unnecessary portion D is able to be reduced, further increasing the cutting efficiency.

Furthermore, in the processing method according to this preferred embodiment, the cleavage regions are formed, by the laser beam, in the unnecessary portion D using a non-thermal processing in the case that the material M is a light-transmitting material. The cleavage regions are formed, by the laser beam, in the unnecessary portion D using a thermal processing in the case that the material M is an opaque material. By using such processing method, the type of the laser beam is able to be changed depending on the light transmittance of the material M. Therefore, it is possible to perform processing regardless of the type of the material.

Furthermore, in the processing method according to this preferred embodiment, in the case that process sites corresponding to the cleavage regions are layered in a direction of projection of the laser beam, the laser beam can be projected to the layered process sites in a descending order of distance from the surface Ms of the material M through which the laser beam passes. By using such processing method, the projected laser beam is not affected by character change. That is, it is unlikely that there remains the problems of impossibility of passing the laser beam through the process site whose characteristics have been changed and the problem of impossibility of precise projection of laser beams to certain process sites because of the refraction of the laser beam through or the reflection of it from the process site whose characteristics have been changed. Accordingly, it is possible to form cleavage regions at the exact process sites that have been set.

Furthermore, in the projection step in the processing method according to this preferred embodiment, the laser beam is projected to a site that has been corrected based on a refractive index of the material M. By adjusting the projection position (focal position) of the laser beam considering the effect of the refractive index of the material M, it is possible to project the laser beams at the exact process sites that have been set.

Furthermore, in the processing method according to this preferred embodiment, in the case that the material M is a light-transmitting material, in the projection step, the laser beam can be projected to the unnecessary portion D after the laser beam is projected to the process site corresponding to the surface Ms of the object S. By projecting the laser beam in the manner just mentioned, it is possible to change character of the material around the object S. This prevents the laser beam from passing through the portion of the material whose characteristics have been changed and reaching on or into the object S when a laser beam is projected to other process sites in the unnecessary portion D.

Furthermore, the processing method according to this preferred embodiment includes a finishing step of removing, after the cutting step, a remaining unnecessary portion D by projecting the laser beam to the remaining unnecessary portion D. This allows processing of the remaining unnecessary portion D that has been left uncut during the cutting step.

The processing system 100 according to this preferred embodiment is the processing system 100 of forming an object S by processing a material M using a cutting tool T and a laser beam, the processing system including the grasper 10 that grasps the cutting tool T; the projector 20 that projects the laser beam; the holder 30 that holds the material M; the driver 40 that moves the grasper 10, the projector 20, and the holder 30 relative to each other; and the controller that controls the projector 20 and the driver 40 such that a cleavage region is formed in an unnecessary portion D of the material M by projecting the laser beam to the unnecessary portion D, and controls the grasper 10 and the driver 40 such that an unnecessary portion D located near the cleavage region formed by projecting the laser beam is cut using the cutting tool T. According to such a processing system 100, processing time is reduced while reducing the effects of deformation and deterioration of the material due to heat.

The processing program according to this preferred embodiment is a processing program executed in a processing system of forming an object S by processing a material M using a cutting tool T and a laser beam, the program causing the processing system to form a cleavage region in an unnecessary portion D of the material M by projecting the laser beam to the unnecessary portion D and cut an unnecessary portion D located near the cleavage region formed by projecting the laser beam using the cutting tool T. By executing such processing program in the processing system 100, processing time can be reduced while reducing the effects of deformation and deterioration of the material due to heat.

It is also possible to supply a program to a computer using a non-transitory computer readable medium with an executable program thereon, in which the processing program in the above preferred embodiment is stored. Examples of the non-transitory computer readable medium include magnetic storage media (e.g. flexible disks, magnetic tapes, and hard disk drives), and CD-ROMs (read only memories).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A processing method for forming an object by processing a material using a cutting tool and a laser beam, the processing method comprising:
a projection step of forming, by projecting the laser beam to an unnecessary portion of the material, one or more cleavage regions in the unnecessary portion; and
a cutting step of cutting, using the cutting tool, the unnecessary portion including the one or more cleavage regions that have been formed.

2. The processing method according to claim 1, wherein two or more cleavage regions are formed in a first direction from a surface of the material by projecting the laser beam.

3. The processing method according to claim 2, wherein an additional two or more cleavage regions are formed in a second direction by projecting the laser beam, the second direction being perpendicular to the first direction.

4. The processing method according to claim 1, wherein the one or more cleavage regions are formed, by the laser beam, in the unnecessary portion using a non-thermal processing when the material is a light-transmitting material, and the one or more cleavage regions are formed, by the laser beam, in the unnecessary portion using a thermal processing when the material is an opaque material.

5. The processing method according to claim 1, wherein, when process sites corresponding to the one or more cleavage regions are layered in a direction of projection of the laser beam, the laser beam is projected to the layered process sites in a descending order of distance from a material surface through which the laser beam passes.

6. The processing method according to claim 1, wherein the laser beam is projected, in the projection step, to a site that has been corrected based on a refractive index of the material.

7. The processing method according to claim 1, wherein, when the material is a light-transmitting material, in the projection step, the laser beam is projected to a process site corresponding to a surface of the object and then the laser beam is projected to the unnecessary portion.

8. The processing method according to claim 1, further comprising:
a finishing step of removing, after the cutting step, a remaining unnecessary portion by projecting the laser beam to the remaining unnecessary portion.

9. A processing system of forming an object by processing a material using a cutting tool and a laser beam, the processing system comprising:
a grasper that grasps the cutting tool;
a projector that projects the laser beam;
a holder that holds the material;
a driver that moves the grasper, the projector, and the holder relative to each other; and
a controller that controls the projector and the driver such that a cleavage region is formed in an unnecessary portion of the material by projecting the laser beam to the unnecessary portion, and controls the grasper and the driver such that an unnecessary portion located near the cleavage region formed by projecting the laser beam is cut using the cutting tool.

10. A non-transitory computer-readable medium including a processing program executed in a processing system to form an object by processing a material using a cutting tool and a laser beam, the program causing the processing system to form a cleavage region in an unnecessary portion of the material by projecting the laser beam to the unnecessary portion and cut an unnecessary portion located near the cleavage region formed by projecting the laser beam using the cutting tool.
